(19) United States
(12) Patent Application Publication
(10) Pub. No.: US 2004/0007819 A1
(43) Pub. Date: Jan. 15, 2004

(54) Method of making objects, such as a target, out of recycled plastic

(76) Inventor: Doug Twichell, Diamondale, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/429,089

(22) Filed: May 2, 2003

Related U.S. Application Data
(60) Provisional application No. 60/377,307, filed on May 2, 2002.

(51) Int. Cl. F41J 1/12; B23P 11/00

(52) U.S. Cl. 273/404; 29/428

(57) ABSTRACT

An object comprising a sleeve having an opening and compressible material within the sleeve. The compressible material being formed by first compressing the material in a first direction, then compressing the material in a second direction perpendicular to the first direction and then compressing the material in a third direction perpendicular to both the first direction and the second direction. The material is placed into the sleeve through the opening along the third direction.

### CROSS-REFERENCE TO RELATED APPLICATION

The present invention claims priority to Provisional Patent Application No. 60/377,307, filed on May 2, 2002 entitled METHOD OF MAKING OBJECTS, SUCH AS A TARGET OUT OF RECYCLED PLASTIC.

### BACKGROUND OF THE INVENTION

The present invention relates to recycling, and in particular to targets made from recycled plastic and a method of making the same.

Targets are used for archery practice by shooting arrows or bolts into the targets. The targets typically include an image of an animal or other indicia indicating a preferred area of the target for aiming and concentric areas surrounding the preferred area signifying the distance from the preferred area. Heretofore, targets have typically been constructed of Styrofoam or similar material that allows the arrows and bolts to easily penetrate the outer surface of the target and also allow easy removal of the arrows or bolts from the targets.

### SUMMARY OF THE INVENTION

One aspect of the present invention is to provide a method of making an object comprising compressing compressible material in a first direction and compressing the compressible material in a second direction, with the second direction being perpendicular to the first direction. The method also includes compressing the compressible material in a third direction, with the third direction being perpendicular to the first direction and the second direction. The method further includes providing a sleeve having an opening therein and moving the compressible material into the sleeve through the opening along the third direction.

Another aspect of the present invention is to provide an object comprising a sleeve having an opening and compressible material within the sleeve. The compressible material is formed by first compressing the material in a first direction, then compressing the material in a second direction perpendicular to the first direction and then compressing the material in a third direction perpendicular to both the first direction and the second direction. The material is placed into the sleeve through the opening along the third direction.

Yet another aspect of the present invention is to provide a target comprising a sleeve having an opening and compressible plastic within the sleeve. The compressible plastic is formed by first compressing the plastic in a first direction, then compressing the plastic in a second direction perpendicular to the first direction and then compressing the plastic in a third direction perpendicular to both the first direction and the second direction. The plastic is placed into the sleeve through the opening along the third direction.

These and other features, advantages, and objects of the present invention will be further understood and appreciated by those skilled in the art by reference to the following specification, claims and appended drawings.

### BRIEF DESCRIPTION OF THE DRAWINGS

FIG. 1 is a perspective view of a target of the present invention.

FIG. 2 is a top view of a press machine illustrating a first step of the method of making objects.

FIG. 3 is a front view of the press machine illustrating a second step of the method of making objects.

FIG. 4 is a top view of the press machine illustrating a third step of the method of making objects.

FIG. 5 is a top view of the press machine illustrating a fourth step of the method of making objects.

FIG. 6 is a cross-sectional view of a second embodiment of the press machine of the present invention.

### DETAILED DESCRIPTION OF THE PREFERRED EMBODIMENTS

For purposes of description herein, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

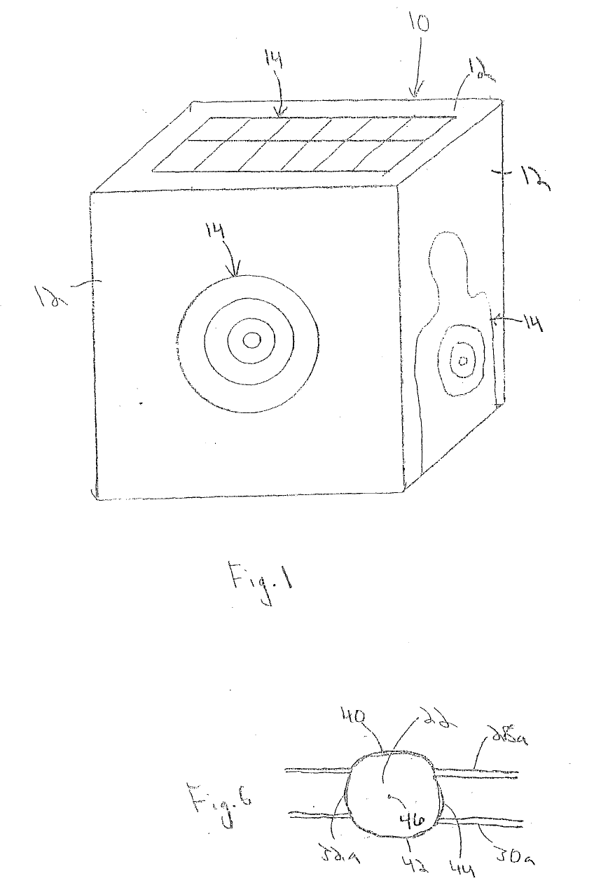

The reference number 10 (FIG. 1) generally designates a target of the present invention made by the method of the present invention. The target 10 is cubic in shape and includes side faces 12 having targets 14 thereon. The target 10 is preferably a cube having two feet by two feet faces and weighing 20 pounds, although it is contemplated that the target 10 could have any shape.

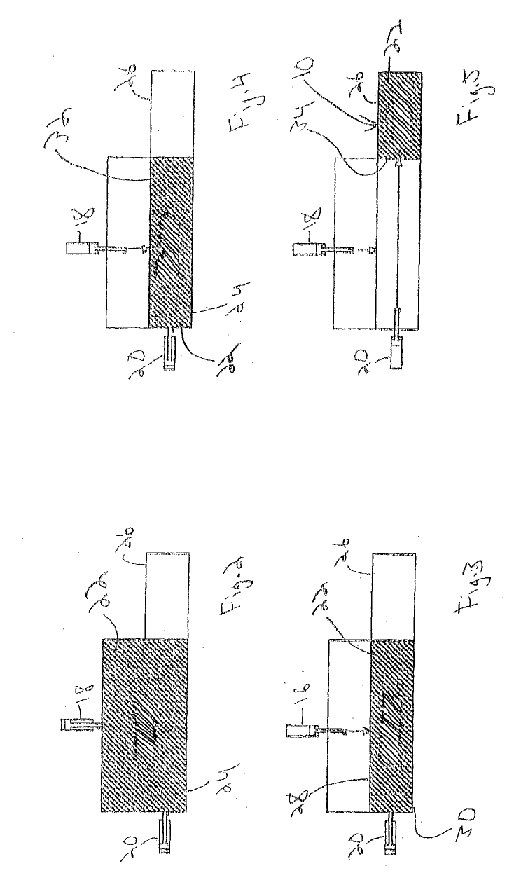

FIGS. 2-5 illustrate the method of making the target 10 or any other rectangular object. The object 10 is preferably made in a press having a first ram 16, a second ram 18 and a third ram 20. The rams 16, 18 and 20 can be gear driven, hydraulic, pneumatic or can be driven in any other way known to those skilled in the art. In the first step as shown in FIG. 2, compressible material 22 to be used in the object 10 is loaded under the first ram 16 (not shown in FIG. 2), between the second ram 18 and a wall 24 and between the third ram 20 and a container or sleeve 26. The compressible material 22 is preferably plastic and most preferably post-consumer polyethylene or polypropylene (e.g., stretch wrap or shrink wrap). Additionally, the container 26 can be formed of any resilient material. Preferably, the container is made out of polyethylene, polypropylene or cardboard. After the material 22 is loaded as illustrated in FIG. 2, the first ram 16 forces a first press 28 in a first direction such that the material 22 is pressed between the first press 28 connected to the first ram 16 and a bottom wall 30 (FIG. 3). Thereafter, as illustrated in FIG. 4, a second press 32 connected to the second ram 18 compacts the material 22 between the second press 32 and the wall 24. The second ram 18 preferably presses the material 22 in a second direction perpendicular to the first direction. Finally, as illustrated in FIG. 5, a third press 34 connected to the third ram 20 will push the material 22 into the container 26 and compress the material a third direction. The third press 34 preferably presses the material 22 in a third direction perpendicular to both the first direction and the second direction. Preferably, the material is compressed to half of its original dimensions by the presses 28, 32 and 34.

It has been found that the material 22 compacted in the directions as illustrated in FIGS. 2-5 advantageously results in an object 10 that is very stable in form and shape and is very useful as a target. Preferably, the object 10 is made without applying heat to the material. In addition to the cubic shape for the object 10 as shown in FIG. 1 and the rectangular shape as shown in FIGS. 2-5, it is contemplated that the object 10 could have any geometric shape. For example, as illustrated in FIG. 6, a disc-shaped object is made by first pressing material between a first flat press 28a having an arcuate portion 40 and a wall 30a having an arcuate portion 42. Then, the material 22 can be pressed between a second press 32a having an arcuate face and a third press 44 having an arcuate face. Finally, the material 22 can be compressed into a cylindrical container in a direction along the axis 46 of the material 22 as illustrated in FIG. 6. As discussed above, it is contemplated that the material 22 can be compacted into additional geometric shapes and pushed into a container 26 having the same geometric shapes. It is further contemplated that the material 22 could slightly expand in the container 26 when the container 26 has any shape, thereby expanding to the shape of the container 26.

It will be readily appreciated by those skilled in the art that modifications may be made to the invention without departing from the concepts disclosed herein. Such modifications are to be considered as included in the following claims, unless these claims by their language expressly state otherwise.

We claim:

1. A method of making an object comprising:
compressing compressible material in a first direction;
compressing the compressible material in a second direction, the second direction being perpendicular to the first direction;
compressing the compressible material in a third direction, the third direction being perpendicular to the first direction and the second direction;
providing a sleeve having an opening therein;
moving the compressible material into the sleeve through the opening along the third direction.

2. The method of making the object of claim 1, wherein:
the compressible material is plastic.

3. The method of making the object of claim 2, wherein:
the plastic is post-consumer plastic.

4. The method of making the object of claim 3, wherein:
the post-consumer plastic is polyethylene.

5. The method of making the object of claim 3, wherein:
the post-consumer plastic is polypropylene.

6. The method of making the object of claim 2, wherein:
moving the plastic into the sleeve through the opening takes place before compressing the plastic in the third direction.

7. The method of making the object of claim 2, further comprising:
providing a press machine having a first press, a second press and a third press;
and further including:
moving the first press in the first direction to compress the plastic in the first direction;
moving the second press in the second direction to compress the plastic in the second direction; and
moving the third press in the third direction to compress the plastic in the third direction.

8. The method of making the object of claim 7, wherein:
the first press, the second press and the third press each have a substantially planar surface contacting the plastic.

9. The method of making the object of claim 7, wherein:
at least one of the first press, the second press and the third press has a non-planar surface.

10. The method of making the object of claim 9, wherein:
the first press and the second press have non-planar surfaces, the non-planar surfaces being arcuate.

11. The method of making the object of claim 2, wherein:
the sleeve is made of polyethylene.

12. The method of making the object of claim 2, wherein:
the sleeve is made of polypropylene.

13. The method of making the object of claim 2, wherein:
the sleeve is made of cardboard.

14. The method of making the object of claim 1, further including:
printing targets on the sleeve.

15. An object comprising:
a sleeve having an opening; and
compressible material within the sleeve;
the compressible material being formed by first compressing the material in a first direction, then compressing the material in a second direction perpendicular to the first direction and then compressing the material in a third direction perpendicular to both the first direction and the second direction, the material also being placed into the sleeve through the opening along the third direction.

16. The object of claim 15, wherein:
the compressible material is post-consumer plastic.

17. The object of claim 16, wherein:
the post-consumer plastic is polyethylene.

18. The object of claim 16, wherein:
the post-consumer plastic is polypropylene.

19. The object of claim 15, wherein:
the sleeve is made of polyethylene.

20. The object of claim 15, wherein:
the sleeve is made of polypropylene.

21. The object of claim 15, wherein:
the sleeve is made of cardboard.

22. The object of claim 15, wherein:
the sleeve includes objects printed thereon.

23. The object of claim 15, wherein:
the sleeve has a cubic shape with the opening forming one side of the cube.

24. A target comprising:
a sleeve having an opening; and
compressible plastic within the sleeve;
the compressible plastic being formed by first compressing the plastic in a first direction, then compressing the plastic in a second direction perpendicular to the first direction and then compressing the plastic in a third direction perpendicular to both the first direction and the second direction, the plastic also being placed into the sleeve through the opening along the third direction.

25. The target of claim 24, wherein:
the compressible plastic is post-consumer plastic.

26. The target of claim 25, wherein:
the post-consumer plastic is polyethylene.

27. The target of claim 25, wherein:
the post-consumer plastic is polypropylene.

28. The target of claim 24, wherein:
the sleeve is made of polyethylene.

29. The target of claim 24, wherein:
the sleeve is made of polypropylene.

30. The target of claim 24, wherein:
the sleeve is made of cardboard.

31. The target of claim 24, wherein:
the sleeve includes targets printed thereon.

32. The target of claim 24, wherein:
the sleeve has a cubic shape with the opening forming one side of the cube.
